(19) United States
(12) Patent Application Publication
(10) Pub. No.: US 2010/0312653 A1
(43) Pub. Date: Dec. 9, 2010

(54) VERIFIABLE ADVERTISEMENT PRESENTATION

(75) Inventors: Todd L. Carpenter, Monroe, WA (US); David Abzarian, Kirkland, WA (US); Seshagiri Panchapagesan, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/478,786

(22) Filed: Jun. 5, 2009

(51) Int. Cl. G06Q 30/00; H04L 9/32; G06K 9/00

(52) U.S. Cl. 705/14.73; 713/176; 382/100

(57) ABSTRACT

The described implementations relate to verifiable advertisement (Ad) presentation in a computing realm, such as a web-based computing realm. In one case verifiable advertisement presentation (VAP) tools can receive advertising (Ad) content to be presented on the computing device. The Ad content can include device-specific data that is uniquely associated with the computing device. The Ad content can be presented on the computing device. The VAP tools can validate that the Ad content was presented on the computing device. In some cases, the validation can include performing a validation function on at least one portion of the Ad content. Performing the function can serve to identify whether the presented content matches sent Ad content.

### BACKGROUND

Computer usage continues to expand relative to types of use and/or hours of use. For example, a user may buy an accounting program and a video game for his/computer. After balancing his/her checkbook the user can pass the hours playing video games. Another user may use a web-based word-processing application to compose a document or play a web-based game. Still another user may surf the web from his/her Smartphone. One aspect that has driven this expansion is advertising. For instance, a company may provide free use of the web-based word-processing application if the user agrees to view advertisements (Ads) before and/or while utilizing the word-processing application. However, given the extent of computer usage, the advertising system remains relatively unsophisticated. For instance, many users game the system so that it appears that he/she viewed the Ads when in actuality they did not. Further, malicious parties may intercept and change the Ads so that what the user actually views is not what was sent to the user. The present concepts advance ad-related computer usage in several ways that can enhance a level of satisfaction for the advertiser and/or the user.

### SUMMARY

The described implementations relate to verifiable advertisement (Ad) presentation in a computing realm, such as a web-based and/or stand-alone computing realm. In one case verifiable advertisement presentation (VAP) tools can receive advertising (Ad) content to be presented on the computing device. The Ad content can be presented on the computing device. The VAP tools can validate that the Ad content was presented on the computing device. In some cases, the validation can include performing a validation function on at least one portion of the Ad content. Performing the function can serve to identify whether the presented content matches sent Ad content.

The term “VAP tool(s)” may refer to device(s), system(s), computer-readable instructions (e.g., one or more computer-readable media having executable instructions), component(s), module(s), and/or methods, among others, as permitted by the context above and throughout the document. In various instances, VAP tools may be implemented as hardware, software, firmware, or any combination thereof. The above listed VAP tool examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1-2 illustrate examples of systems for accomplishing verifiable Ad presentation in accordance with some implementations of the present concepts.

FIGS. 3-5 are flowcharts for implementing verifiable Ad presentation in accordance with some implementations of the present concepts.

### DETAILED DESCRIPTION

### Overview

This patent application relates to verifiable advertisement (Ad) presentation in a computing realm, such as a web-based computing realm.

In one case, verifiable advertisement presentation (VAP) tools can receive Ad content to be presented on the computing device. The Ad content can be presented on the computing device, such as visually and/or audibly for the user. The VAP tools can validate that the Ad content was presented on the computing device. In some cases, the validation can include performing a function on at least one portion of the Ad content. Performing the function can serve to identify whether the presented content matches sent Ad content.

In summary, from a functional perspective the VAP tools aid in determining whether Ad content is actually presented on a user's computing device as intended. In one case, the VAP tools can aid in secure delivery of Ad content to a client computing device. The VAP tools can then securely validate that the Ad content has been correctly presented on the client computing device. Finally, the VAP tools can verify the computing device's validation.

### First System Example

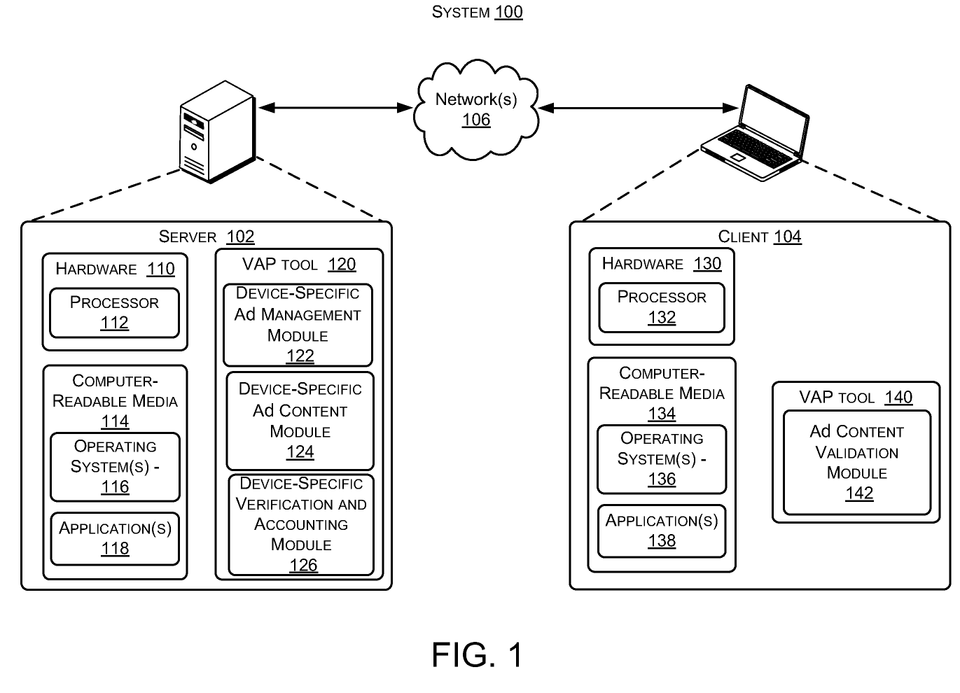

FIG. 1 offers an introductory system 100 for accomplishing verifiable Ad content presentation. In this case, system 100 includes a server computing device(s) 102 and a client computing device 104. Server computing device 102 may be referred to herein as “server” 102. Similarly, client computing device 104 may be referred to as “client” 104. Server 102 and client 104 can be communicatively coupled via a network 106, such as the Internet. In this case, client 104 is manifest as a notebook computer. In other cases, the client can be manifest as a desktop computer, cell phone, smart phone, personal digital assistant (PDA), netbook, or any other type of ever-evolving types of computing devices.

In this implementation, server 102 includes a hardware layer 110 that includes a processor(s) 112 for executing computer-readable instructions. While not specifically shown, hardware layer 110 can also include, and/or be configured to be in communication with, various hardware devices. Non-limiting examples of these hardware devices can include input devices, such as a keyboard and/or mouse and/or output devices, such as displays and/or speakers, among others.

Server 102 can also include computer-readable media 114 upon which can be stored on operating system 116 and application(s) 118. In this case, server 102 can also include a VAP tool 120. The VAP tool can include a device-specific Ad management module 122 (hereinafter, (Ad management module”), a device-specific Ad content module 124 (hereinafter, “Ad content module”), and a device-specific verification and accounting module 126 (hereinafter, “verification module”). Modules 122-126 can be manifested as software, hardware, and/or firmware. In one instance, modules 122-126 can be stored on computer-readable media 114.

In this example, client 104 includes a hardware layer 130 that includes a processor(s) 132 for executing computer-readable instructions. Client 104 also includes computer-readable media 134, an operating system 136 and application(s) 138. Client components 130-138 can be similar in nature to the corresponding components 110-118 of server 102 and as such are not described in more detail for sake of brevity. In this instance, client 104 includes a VAP tool 140 that aids in verifiable Ad presentation. The VAP tool can also include an Ad content validation module 142 (hereinafter, “validation module”) that can be stored on computer-readable media 134, among other configurations.

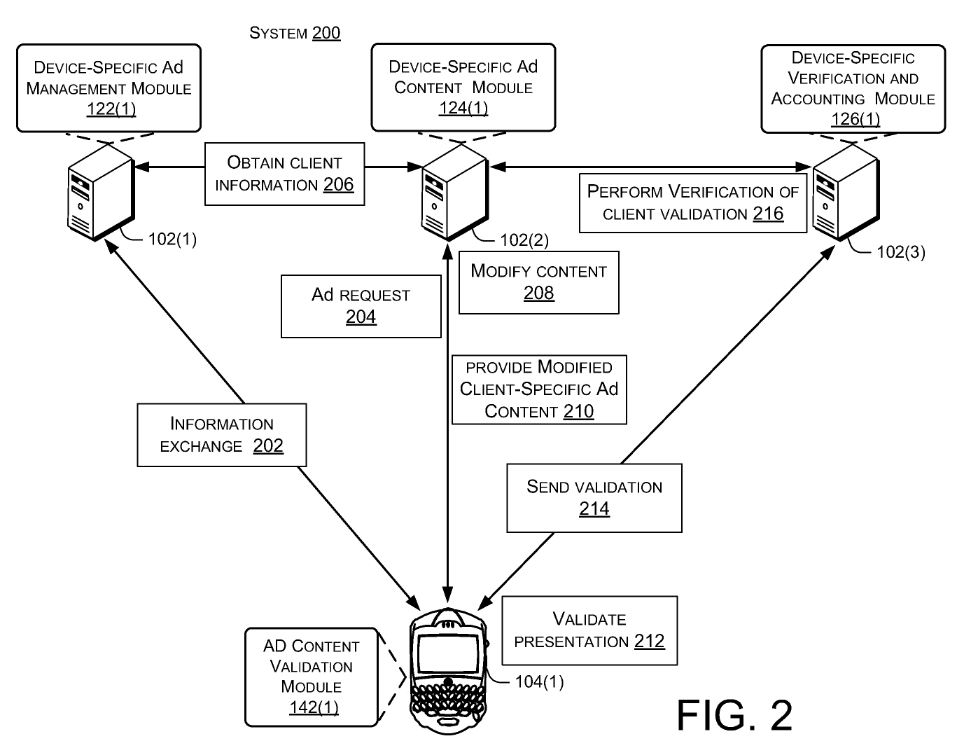

In relation to verifiable Ad content presentation, the function of the server's Ad management module 122, Ad content module 124, and verification module 126 are introduced briefly here, and are described in more detail below by way of example in relation to FIG. 2.

Ad management module 122 can register client 104 for verifiable advertisement presentation (VAP). The client can be registered utilizing information that is uniquely associated with the client (i.e., information that is unique to the client). Briefly, examples of such unique information can include security tokens, email addresses, and IP addresses, among others. Other examples are described below in relation to FIG. 2.

Ad content module 124 can receive an Ad content request from client 104. In some cases, the Ad content request can include a unique identification of client 104. The Ad content module 124 can also verify the registration of the client with the Ad management module 122. For instance, the Ad content module can utilize the unique identification in the verification process. In some configurations, the Ad content module may communicate with the Ad Management Module to ensure that a specific client request is valid. For instance, the Ad content module may check to ensure that the client request is consistent with the client's registration information and/or conditions,

In some implementations, the Ad content module 124 can associate the Ad content with the unique client identification and/or other potentially useful information related to the client, a user of the client, and/or a specific instance of the content request, time stamp, etc. Ad content module 124 can then provide the Ad content to the client. In some cases, the associating can include modifying or customizing the Ad content for the client using the unique client information. In some configurations, modifying the Ad content can include marking the Ad content with the client's unique information.

In some cases, the Ad content module 124 can target Ad content to the client 104. For instance, Ad content can be selected for the client 104 based upon the information provided by the client. For example, if this information indicates that the client is a hypothetical XYZ brand computing device then Ad content may be selected that is directed toward XYZ users.

In implementations that modify the Ad content, the Ad content module 124 can modify the selected Ad content for the client 104 utilizing one or more techniques, such as watermarking, fingerprinting, steganography and/or other encryption techniques. For instance, the Ad content module can embed the device-specific data in the Ad content as a steganographic message. Stated another way, the device-specific data can be embedded in the Ad content in a way in which only an application or filter designed to look for the embedded content will be able to interpret it.

The client 104 can receive the Ad content and present the content for the user. The client's validation module 142 can function to determine whether the Ad content that was sent to the client 104 from the server 102 was actually presented on the client. For instance, the validation module 142 may determine whether the client's unique identification occurs in the presented content. In an instance where the unique identification is located in Ad content that is presented on the client, then the validation module can validate that the content was presented on the client for the user.

The server's verification module 126 can be configured to verify that the Ad content has been presented on the client 104. For instance, the verification module may compare the Ad content sent to the client 104 to content that was actually presented on the client. So for example, if the sent Ad content matches the presented Ad content then the verification is satisfied. In contrast, if no content is presented on the client or if the presented content does not match the sent content then the verification fails. In summary, this functionality can serve to ensure that rogue software on the network or the local machine does not alter the contents sent by the server. Alternatively or additionally, the verification module can verify that any client that claims to have presented the Ad content was, in fact, the intended recipient of the Ad content. For instance, the verification module can compare information from the server about the client to information from the client to determine whether they are one-in-the-same.

System 100 is explained in a basic setting with server 102 and client 104 in a one-to-one relationship. The skilled artisan should recognize that the described server functionality can be offered to multiple different clients. In each case, an individual client can receive Ad content that is associated with that client. Further, verification can be performed to determine whether the Ad content intended for a specific client was presented on that client. In still other instances, a single client may include multiple users. In such a case, the server can perform the above described VAP functionality for individual users.

In system 100 the Ad management module 122, Ad content module 124, and the verification module 126 occur on a single server. FIG. 2 offers an alternative configuration where individual modules reside on separate servers. The separate servers may or may not be controlled by the same entity.

### Second System Example

FIG. 2 offers another system 200 for accomplishing verifiable advertisement presentation (VAP). In this case, system 200 includes three distinct servers 102(1), 102(2), and 102(3) and a client 104(1). Also, client 104(1) includes validation module 142(1). As used herein, the parenthetical suffix of a designator (i.e., “(1)”, “(2)”, etc) is utilized to indicate another implementation of a component which has been previously introduced). In system 200, server 102(1) includes Ad management module 122(1). As such, server 102(1) can be referred to as the “Ad management server”. Server 102(2) includes Ad content module 124(1) and as such as can be referred to as the “Ad content server”. Similarly, server 102(3) includes verification module 126(1) and can be referred to as the “verification server”. As should be recognized by the skilled artisan, servers 102(1)-102(3) can all be controlled by a single entity or individual servers can be controlled by different entities. System 100, introduced above, illustrates an implementation where all of these modules exist on a single server. In still other configurations, any two of modules 122(1), 124(1), and 126(1) can occur on a single server with the remaining component occurring on a different server.

For purposes of explanation consider a hypothetical usage scenario that can be supported by system 200 where a user of client 104(1) wants to participate in a VAP program. The user may want to participate in the VAP program for several reasons. For example, the user may surf to a website that offers the user money or credits in exchange for participating in the VAP program. In another example, the user may be offered additional functionalities in exchange for participating in the VAP program. In one such example, the user may be using a basic version of an application, operating system, or game and may be offered an enhanced version for participating in the VAP program. Of course, the user need not be aware that he/she is participating in a VAP program. Instead, the user may simply view an Ad feed in a standard manner without having any understanding of the underlying VAP processes. The underlying system can configure the supplied Ad feed as part of a VAP program without any further knowledge and/or input by the user.

Regardless of how the VAP program or process is initiated, an exchange of information 202 can occur between client 104(1) and Ad management server 102(1). Briefly, the information can include some information about client 104(1) and establish a unique identification for the client. Such information can relate to the client's IP address, time of request, request size, geographical location, web-browsing history, security tokens, etc. Still other examples can relate to hashes/digests of hardware identifiers, such as MAC address, serials numbers, etc., related to the client. Some implementations may gather personal information about a user of client 104(1) in order to better select Ad content to send to the user. For instance, if the user indicates that he/or she is interested in cars then the VAP system can select car related Ad content for the user. However, there are certainly lots of implementations that need not gather any personal information about the user and/or can allow the user to opt out of providing any personal information.

Ad management server 102(1) can use the information of block 202 to uniquely identify client 104(1). For instance, a client email address may be used as a unique identifier for the client. In other cases, the Ad management server may process the information obtained from the client to generate the unique identification. For instance, the server may perform a hash on the client information to generate the unique identification. Either way, some unique identification can be generated for referring to the client.

The Ad management server 102(1) can send the unique identification to the client 104(1) for future use as will be described below. For instance, the Ad management server can send the client a data packet that contains the unique identification, such as in the form of a security token. The data packet can also include information about Ad content server 102(2). For instance, the information can relate to location and/or request information, among others, of the Ad content server.

The exchange of client information can be beneficial at both the server side and the client side. On the client side, the exchange of information can allow the user to specify his/her interests so that the Ad content that is ultimately viewed is more interesting to the client's user. On the server side, advertisers can target the Ad content to the user based upon a multitude of factors specified in the client information, such as type of computing device, viewing habits, geographical location, and user specified interests, among others. This can increase satisfaction at the advertiser's end since the advertiser knows that the content is germane to the user (i.e., targeted advertising).

The Ad management server 102(1) can store the client information in a database referenced by the client's unique identification. In one configuration, the Ad management server 102(1) can forward the client's information and the Ad content request to the Ad content server 102(2). In such a case, the Ad management server can select an appropriate Ad content server based upon the client information. For instance, if the user is interested in photography, the Ad management server may send the user's information to an Ad content server hosted by a company that provides cameras and/or photography-related merchandise. Alternatively or additionally, the Ad content server may be configured to obtain content from multiple different sources such that it can select Ad content for the client.

In another configuration, information exchange 202 can culminate with Ad management server 102(1) sending client 104(1) a packet that includes a security token for the client and information, such as the IP Address of Ad content server 102(2).

In this latter configuration, at 204, the client 104(1) can send an Ad request to Ad content server 102(2). The Ad request can include the unique identification of the client. The Ad content server can select (and/or otherwise obtain) Ad content for client 104(1). For instance, the Ad content server can utilize the client's unique identification to request ‘client-specific information’ and/or ‘request specific information’ from the Ad management server at 206. ‘Request specific information’ can contain some of the client's unique information as well as information about the request. For instance, the request specific information can specify that the client is requesting specific Ad content for presentation on the client for one occurrence and/or at a specific date and time. Thus, request specific information can be used subsequently to prevent replay attacks for credits. For example, such a configuration can detect an occurrence where the request specific information indicates that the Ad content is for a single presentation, but award requests are received for multiple presentations.

The Ad content can be in the form of video, audio, and/or image content, among others. The Ad content server 102(2) can select Ad content that is client-specific based upon the client information obtained from the Ad management server's database. For instance, if the user is playing a game on the client, then the Ad content server may select Ad content relating to accessories for the game and/or Ads for other games that may be of interest to the user according to the client information.

In some implementations, the Ad content server 102(2) can modify the selected Ad content at 208 utilizing the client's unique identification (and/or other client information) to create client-specific modified Ad content for client 104(1). In one case, the Ad content server can utilize steganography to embed client-specific information in the selected Ad content. Other techniques for modifying the Ad content can include one or more of watermarking, fingerprinting and hashing, among others. In summary, some or all of the client information can be utilized to modify the selected content to make that content specific to the client.

The Ad content server 102(2) can provide the client-specific Ad content at 210. In one case, the client-specific modified Ad content can be sent to the client 104(1) as device or client-specific Ad content data packet(s). In other implementations, Ad content that is associated with the client, but is unmodified can be provided by server 102(2) to client 104(1).

In the illustrated case, client 104(1) can present the client-specific modified Ad content for the user. The client can validate that the client-specific modified Ad content was presented for the user at 212. For instance, the client's content validation module 142(1) can perform a function on the presented content using one of several validation methods to validate that the modified content was presented. In one case, the validation method entails performing a steganographic calculation on presented content. In another case, the function can entail a hash or finger printing algorithm. In a further case, the validation can entail a watermark calculation. In still another case, the validation can entail a remote user session loopback stream validation. Remote user sessions, and user session capture techniques for leveraging remote user sessions, are described below.

At 214, the client 104(1) can send the results from the validation and the unique identification to verification server 102(3). The verification server 102(3) can obtain information relating to the modified Ad content that was sent to the client. For instance, the verification server can obtain this information from the Ad content server 102(2).

The verification server can then verify the client validation at 216. For instance, the verification server can compare the modified Ad content that was sent to the client to the validation obtained from the client to verify whether the sent content was the same content that was actually presented on the client.

The verification server 102(3) can also verify that the client that sent the validation is the intended client (i.e., the client associated with the content). This aspect of the verification can prevent third parties from claiming that they viewed the Ad content and should be rewarded, when, in fact, the Ad content was not intended for them. When the verification is successful, the verification server can reward the client, such as by crediting an account associated with the client or by allowing the client to utilize additional features on an application, etc. The above described configuration greatly enhances an advertiser's willingness to pay for advertising, since system 200 can verify that the advertising content was actually presented for the intended user on client 104(1) (i.e., verifiable Ad presentation).

### Remote User Session Example

Remote user sessions can allow computing experiences of a user to be captured. A remote user session can be thought of as a process that leverages a defined protocol for capturing a user's computing experience. For instance, in relation to Microsoft brand Windows® Operating System (OS), the defined protocol is known as remote desktop protocol (RDP). The defined protocol can be configured to convert a computing experience into a compressed packet stream. User session capture techniques can manipulate where and/or how the defined protocol gathers the user experience (i.e., the input). User session capture techniques can also manipulate where the defined protocol's output is directed and what is done with the output. This output can be utilized by the VAP tools to validate that Ad content was presented on the user's computing device. Further details regarding leveraging remote user sessions can be found in U.S. patent application Ser. No. ______, having attorney docket number 326869.01, titled “Capturing a Computing Experience” and assigned to the assignee of the present application.

### First Method Example

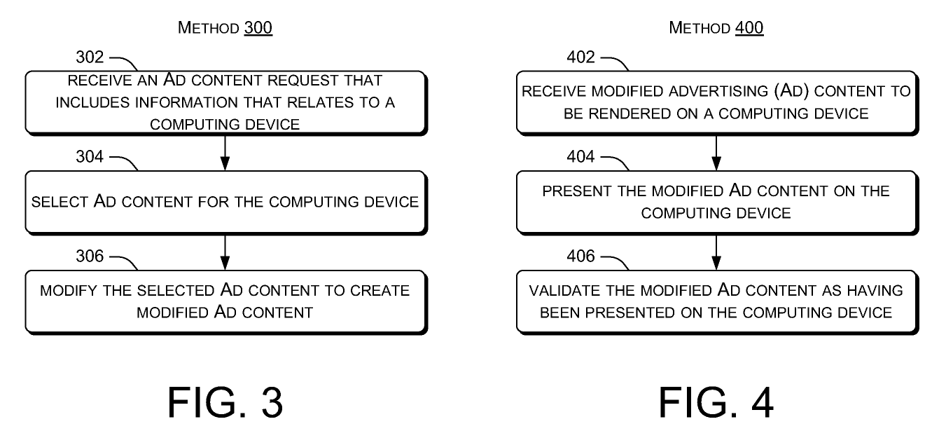

FIG. 3 shows a flowchart of a VAP method or technique 300 that is consistent with at least some implementations of the present concepts. The order in which the method 300 is described is not intended to be construed as a limitation, and any number of the described blocks can be combined in any order to implement the method, or an alternate method. Furthermore, the method can be implemented in any suitable hardware, software, firmware, or combination thereof, such that a computing device can implement the method. In one case, the method is stored on a computer-readable storage media as a set of instructions such that execution by a computing device causes the computing device to perform the method.

At block 302 the method receives an Ad content request that includes information that relates to a computing device. In some cases, the information can include a unique identification of the computing device and information relating to the computing device. This information can relate to one or more different factors associated with the computing device and as such can be thought of as device-specific data. Examples of this device-specific data are described above in relation to FIGS. 1-2 as client-specific data. In an instance where the Ad content request does not include a unique identifier for the computing device the method can create a unique identifier. For example, the unique identifier can be created by hashing the device-specific data.

At block 304, the method selects Ad content for the computing device. In some cases, the method can utilize the device-specific data relating to the computing device to select specific Ad content. For example, the method may look at the browsing history of the computing device and match the selected Ad content to the browsing history.

At block 306, the method modifies the selected Ad content to create modified Ad content. The method can modify the selected Ad content utilizing the device-specific data. For instance, some or all of the device-specific data can be incorporated or embedded into the selected Ad content to create the modified Ad content for the computing device.

### Second Method Example

FIG. 4 shows a flowchart of a VAP method or technique 400 that is consistent with at least some implementations of the present concepts. The order in which the method 400 is described is not intended to be construed as a limitation, and any number of the described blocks can be combined in any order to implement the method, or an alternate method. Furthermore, the method can be implemented in any suitable hardware, software, firmware, or combination thereof, such that a computing device can implement the method. In one case, the method is stored on a computer-readable storage media as a set of instructions such that execution by a computing device causes the computing device to perform the method.

At block 402, the method receives modified advertising (Ad) content to be presented on a computing device. The modified Ad content can include device-specific data uniquely associated with the computing device. For instance, as discussed above, device-specific data can be incorporated or embedded into the modified Ad content, such as via steganography. In some scenarios, the computing device can make a request to receive the Ad content, such as in the form of an Ad feed. The modified Ad content is then supplied in response to the request. In other cases, information can be gathered about the computing device. Modified Ad content can be created for the computing device with the information. The modified Ad content can then be offered to a user of the computing device.

At block 404, the method presents the modified Ad content on the computing device. For instance, the modified Ad content can be visible and/or audibly presented on the computing device.

At block 406, the method validates the modified Ad content as having been presented on the computing device. The validating can include performing a function on a presented portion of the modified Ad content. In some cases, the device-specific data may be randomly distributed in the Ad content. In other cases, the device-specific data may be localized in a particular region. For instance, the function can analyze whether the device-specific data is incorporated in, for example, the upper right corner of the presented content. In one case, the method provides the validation in an instance where content is presented on the computing device and where the presented content contains the expected device-specific data.

### Third Method Example

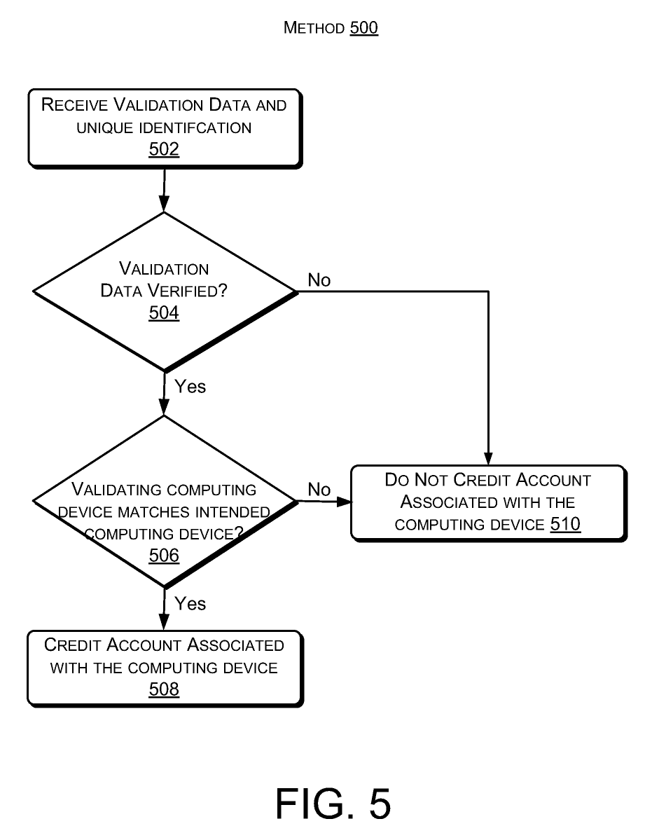

FIG. 5 shows a flowchart of a VAP method or technique 500 that is consistent with at least some implementations of the present concepts. The order in which the method 500 is described is not intended to be construed as a limitation, and any number of the described blocks can be combined in any order to implement the method, or an alternate method. Furthermore, the method can be implemented in any suitable hardware, software, firmware, or combination thereof, such that a computing device can implement the method. In one case, the method is stored on a computer-readable storage media as a set of instructions such that execution by a computing device causes the computing device to perform the method.

At block 502 the method receives validation data that Ad content has been presented on a computing device and a unique identification of the computing device. In one case, the unique identification can be in the form of one or more security tokens uniquely associated with the computing device.

At block 504, the method verifies that the Ad content has been presented on the computing device by matching the received validation data with expected validation data. For instance, the method can obtain information relating to the Ad content from a source of the Ad content. The method can then compare the information from the source with validation data obtained from the computing device. If the validation data is verified (i.e., yes at 504), then the method proceeds to block 506, otherwise the method proceeds to block 510. In summary, this block can serve to ensure that the presented Ad content matches the sent Ad content.

At block 506, the method verifies that the computing device that presented the Ad content is the same computing device that is registered to receive the Ad content. In one case, the method verifies Ad registration of the computing device for the Ad content by comparing one or more received security tokens with one or more expected security tokens recorded during an Ad request registration process. In one implementation, the method can compare an encrypted value obtained from the presenting computing device to an encrypted value generated during a computing device registration process to verify that the intended computing device presented the Ad content. Thus, the method can protect against awarding fraudulent or unwarranted Ad credits.

If the validating computing device matches the intended computing device (i.e., yes at 506) then the method proceeds to block 508. Otherwise, the method proceeds to block 510. In summary, this method can serve to ensure that the computing device requesting credit for presenting the Ad content was the intended recipient of that Ad content.

At block 508, the method credits an account associated with the computing device for presenting the Ad content. The crediting can be a monetary crediting, such as crediting cash, coupons, bonus points, etc. In another instance, the crediting can relate to crediting the computing device with permission to use an upgrade or other enhancement for a period of time. For instance, the credit can relate to allowing the computing device to run enhanced game or application features for a period of time. In some cases, the crediting can be based on the received validation data and/or the received tokens(s). Some implementations can give incremental credit (i.e., partial credit for presenting part of the content). Other implementations can give credit only if all of the Ad content is presented. Further still, some implementations can give more credit for presenting an individual ad to a user's computing device that provides more personal information than to a user that provides less personal information. Still other implementations may award higher credit levels to users that view relatively high volumes of ads.

If the method does not proceed to block 508, then the method proceeds to block 510. At block 510 the method does not credit an account associated with the computing device since the verification process failed. The verification process can fail because the Ad content that was sent was not actually presented on the computing device and/or the computing device requesting the credit is not the computing device for which the Ad content was intended.

### Conclusion

Although techniques, methods, devices, systems, etc., pertaining to verifiable Ad presentation are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A computer-readable storage media having instructions stored thereon that when executed by a computing device cause the computing device to perform acts, comprising:
receiving advertising (Ad) content to be presented on the computing device;
presenting the Ad content on the computing device; and,
validating the Ad content as having been presented on the computing device, the validating comprising performing a function on at least one portion of the Ad content.

2. The computer-readable storage media of claim 1, wherein the receiving comprising receiving Ad content that is modified for the computing device.

3. The computer-readable storage media of claim 2, wherein the Ad content is modified with device-specific data uniquely associated with the computing device.

4. The computer-readable storage media of claim 3, wherein the device-specific data is embedded in the modified Ad content as a steganographic message or a watermark.

5. The computer-readable storage media of claim 1, wherein the receiving comprising receiving Ad content that is modified for an individual user of the computing device.

6. The computer-readable storage media of claim 1, wherein the receiving, presenting, and validating can be repeated for multiple individual users of the computing device.

7. The computer-readable storage media of claim 1, wherein the receiving occurs responsive to a request for Ad content, and wherein the request is generated on the computing device.

8. The computer-readable storage media of claim 7, wherein the request includes data relating to a user of the computing device.

9. The computer-readable storage media of claim 1, further comprising prior to receiving the Ad content, receiving a token uniquely associated with the computing device.

10. The computer-readable storage media of claim 9, prior to receiving the Ad content, providing the token to a device other than the computing device to request the Ad content.

11. The computer-readable storage media of claim 1, further comprising sending, to a device other than the computing device, validation data that can be used to verify the validating.

12. The computer-readable storage media of claim 1, wherein the performing the function comprises one or more of:
performing a steganographic calculation on the at least one portion to discover device-specific data;
performing a steganographic calculation on the at least one portion to discover user-specific data;
performing a hash function on the at least one portion;
performing a fingerprinting function on the at least one portion;
performing a watermark calculation on the at least one portion to discover device-specific data;
performing a watermark calculation on the at least one portion to discover user-specific data; or,
performing a Remote Desktop Protocol (RDP) function on the at least one portion.

13. A method, comprising:
receiving validation data that advertising (Ad) content has been presented on a computing device and one or more security tokens uniquely associated with the computing device;
verifying that the Ad content has been presented on the computing device by matching the received validation data with expected validation data;
verifying Ad registration of the computing device for the Ad content by comparing the one or more received security tokens with one or more expected security tokens recorded during the Ad registration; and,
crediting an account associated with the computing device for presenting the Ad content.

14. The method of claim 13, wherein the matching of the received validation data with the expected validation data comprises calculating the expected validation data based on requested Ad content sent to the computing device and the one or more received security tokens.

15. The method of claim 13, wherein the crediting comprises crediting the account with a value based at least in part on the received validation data or the one of more received security tokens.

16. A system, comprising:
a device-specific advertising (Ad) management module configured to register at least one computing device utilizing a unique identification of the at least one computing device and device-specific data relating to the at least one computing device; and,
a device-specific Ad content module configured to:
receive an Ad content request that includes the unique identification of the computing device;
verify, utilizing the unique identification, registration of the computing device with the device-specific Ad management module; and
provide, utilizing the unique identification, Ad content uniquely associated with the computing device.

17. The system of claim 16, wherein the unique identification comprises a security token that includes a unique encrypted value.

18. The system of claim 16, wherein the device-specific Ad content module is configured to utilize the unique identification to obtain the device-specific data from the device-specific advertising module and to incorporate the device specific data in the Ad content to create modified Ad content.

19. The system of claim 16, wherein the device-specific advertising (Ad) management module and the device-specific Ad content module are configured to support multiple users of the computing device.

20. The system of claim 16, further comprising a verification and accounting module configured to verify that the Ad content has been presented on the computing device.
